(19) United States
(12) Patent Application Publication
(10) Pub. No.: US 2015/0219170 A1
(43) Pub. Date: Aug. 6, 2015

(54) HYDRAULIC MODULAR POWER TRANSFER UNIT ASSEMBLY INCLUDING A DISCONNECT MECHANISM USING AUTOMATIC TRANSMISSION LINE PRESSURE

(71) Applicant: GM GLOBAL TECHNOLOGY OPERATIONS LLC, Detroit, MI (US)

(72) Inventor: Craig R. Brooks, Harrison Township, MI (US)

(73) Assignee: GM GLOBAL TECHNOLOGY OPERATIONS LLC, Detroit, MI (US)

(21) Appl. No.: 14/602,404

(22) Filed: Jan. 22, 2015

Related U.S. Application Data
(60) Provisional application No. 61/934,400, filed on Jan. 31, 2014.

(51) Int. Cl. F16D 48/02; F16H 57/029; B60K 17/02; F16H 1/14; F16D 25/061

(52) U.S. Cl. CPC F16D 48/02; F16H 1/145; F16D 25/061; B60K 17/02; F16H 57/029; F16D 2048/0293; F16H 2702/02

(57) ABSTRACT

A power transfer unit assembly transfers torque from a powertrain to a propeller shaft. The power transfer unit assembly includes an input shaft, a transfer shaft, and a disconnect mechanism disposed between the input shaft and the transfer shaft. The transfer shaft is meshingly engaged with the driven member. The input shaft is selectively rotatably driven by the powertrain about a first axis of rotation and the drive member is selectively rotatably driven by the powertrain about a second axis of rotation. The disconnect mechanism is selectively engaged and disengaged. When the disconnect mechanism is engaged, torque is transferred from the input shaft to the driven member, via the transfer shaft. When the disconnect mechanism is disengaged, the input shaft is disconnected from the transfer shaft such that torque is not transferred from the input shaft to the driven member.

### CROSS-REFERENCE TO RELATED APPLICATIONS

This application claims the benefit of U.S. Provisional Application No. 61/934400, filed Jan. 31, 2014, which is hereby incorporated by reference in its entirety.

### TECHNICAL FIELD

The present teachings generally include a hydraulic power transfer unit assembly including a disconnect mechanism using automatic transmission line pressure for an all-wheel drive vehicle.

### BACKGROUND

Power transfer units (PTUs) are used in some vehicles to distribute driving torque provided from an engine and transmission to the right front wheel and both rear wheels of a vehicle. In some other arrangements the right side half shaft passes through the PTU and is not considered part of the PTU. For example, some power transfer units only transfer torque from a transverse transmission differential to a propeller shaft, which then drives rear half shafts through a rear differential. A hypoid gear set is often used to accomplish the 90 degree turn in the direction of drive between the front differential carrier axis of rotation and the propeller shaft axis of rotation. The torque ratio that the hypoid gear set can provide is dependent on the relative tooth counts of the hypoid ring gear and the pinion gear. The diameters of these gears are limited by available packaging space.

### SUMMARY

One aspect of the disclosure provides a power transfer unit assembly for selectively transferring torque from a powertrain to a driven member of a vehicle to a driven member. The power transfer unit assembly includes an input shaft, a transfer shaft, a propeller shaft, and a disconnect mechanism. The input shaft is configured to be rotatably driven by an output shaft of the powertrain, about a first axis of rotation. The transfer shaft concentrically surrounds the input shaft. The transfer shaft has a first bevel gear. The first bevel gear is configured to be meshingly engaged with the driven member to selectively rotatably drive the driven member about a second axis of rotation. The disconnect mechanism is disposed between the input shaft and the transfer shaft. The disconnect mechanism is configured to selectively drive the transfer shaft by the input shaft. The input shaft is disconnected from the transfer shaft and torque is not transferred to the driven member when the disconnect mechanism is disengaged. Likewise, the input shaft is operatively connected to the transfer shaft and torque is transferred from the input shaft to the driven member when the disconnect mechanism is in the engaged position.

Another aspect of the disclosure provides a powertrain for a vehicle. The powertrain includes a transmission, a front differential, a helical gear, a propeller shaft, and a power transfer unit assembly. The transmission includes an output member. The front differential includes a differential carrier. The helical gear is operatively attached to the differential carrier of the front differential such that the transmission output member is configured to rotate in unison with the differential carrier. The differential carrier is rotatable about a first axis of rotation. The power transfer unit assembly includes an input shaft, a transfer shaft, and a disconnect mechanism. The input shaft is configured to be rotatably driven by the differential carrier about a first axis of rotation. The transfer shaft concentrically surrounds the input shaft. The transfer shaft has a first bevel gear. The first bevel gear is meshingly engaged with the propeller shaft to selectively rotatably drive the propeller shaft about a second axis of rotation. The disconnect mechanism is disposed between the input shaft and the transfer shaft. The disconnect mechanism is configured to selectively drive the transfer shaft by the input shaft. The input shaft is disconnected from the transfer shaft and torque is not transferred to the propeller shaft when the disconnect mechanism is disengaged. Likewise, the input shaft is operatively connected to the transfer shaft and torque is transferred from the input shaft to the propeller shaft when the disconnect mechanism is in the engaged position.

This arrangement significantly reduces drag and noise, vibration, and harshness (NVH). The input shaft is disconnected from the first bevel gear such that torque is not transferrable from the input shaft to the first bevel gear when the disconnect mechanism is in the disengaged position. The input shaft is operatively connected to the first bevel gear to enable torque transfer from the input shaft to the first bevel gear when the disconnect mechanism is in the engaged position.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic, diagrammatic view of a vehicle having a powertrain including a power transfer unit.

FIG. 2A is a schematic partially cross-sectional and fragmentary view of the vehicle having a powertrain with the power transfer unit assembly surrounding a front half shaft.

FIG. 2B is a schematic partially cross-sectional and fragmentary view of a portion of the power transfer unit assembly of FIG. 2A having a disconnect mechanism, where the disconnect mechanism is illustrated in a disengaged position and an engaged position.

### DETAILED DESCRIPTION

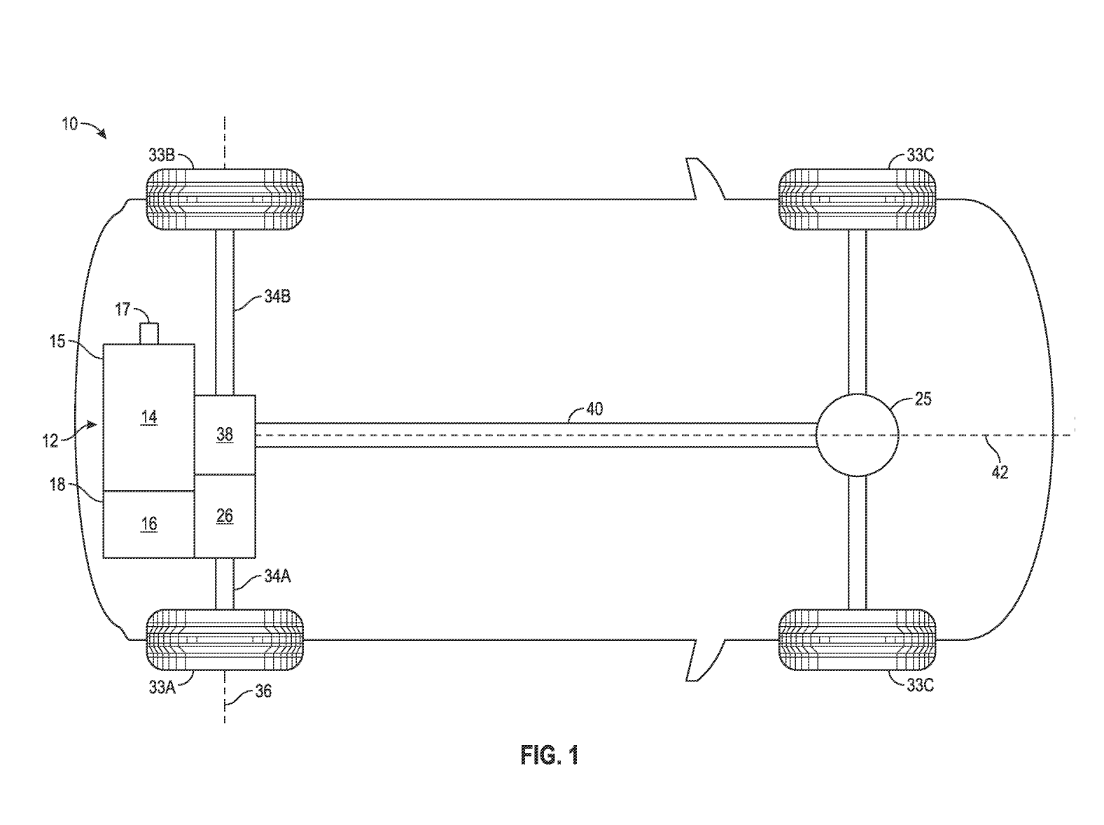

Referring to the drawings, wherein like reference numbers refer to like components throughout the several views, a vehicle 10 having a powertrain 12 is shown in FIG. 1. The powertrain 12 includes an engine 14, a transmission 16, a front differential 26, and a power transfer unit 28. The engine 14 drives the transmission 16, which may be a multi-speed transmission 16. The engine 14 has an engine block 15. A crankshaft 17 extends from within the engine block 15 to connect with a transmission input member (not shown), as is understood by a person skilled in the art. The transmission 16 can include a gearing arrangement and a plurality of manually or hydraulically engageable clutches that provides torque at a transmission output shaft 20, as shown in FIG. 1A. Alternatively, a continuously variable transmission arrangement can be used instead of a gearing arrangement and clutches. The transmission 16 has a transmission housing 18.

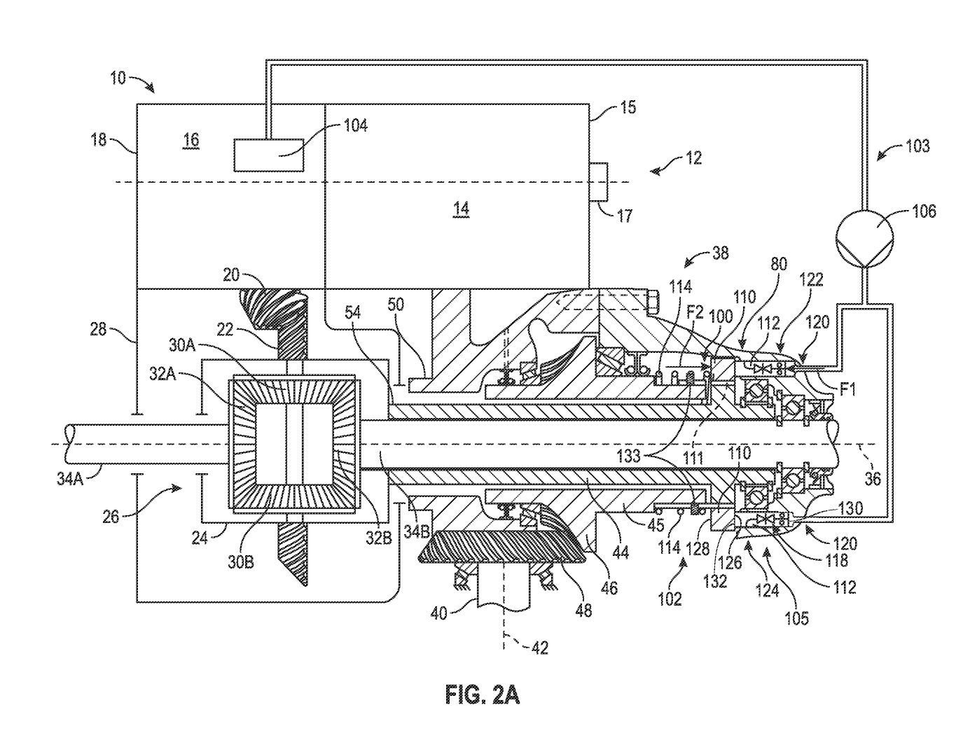

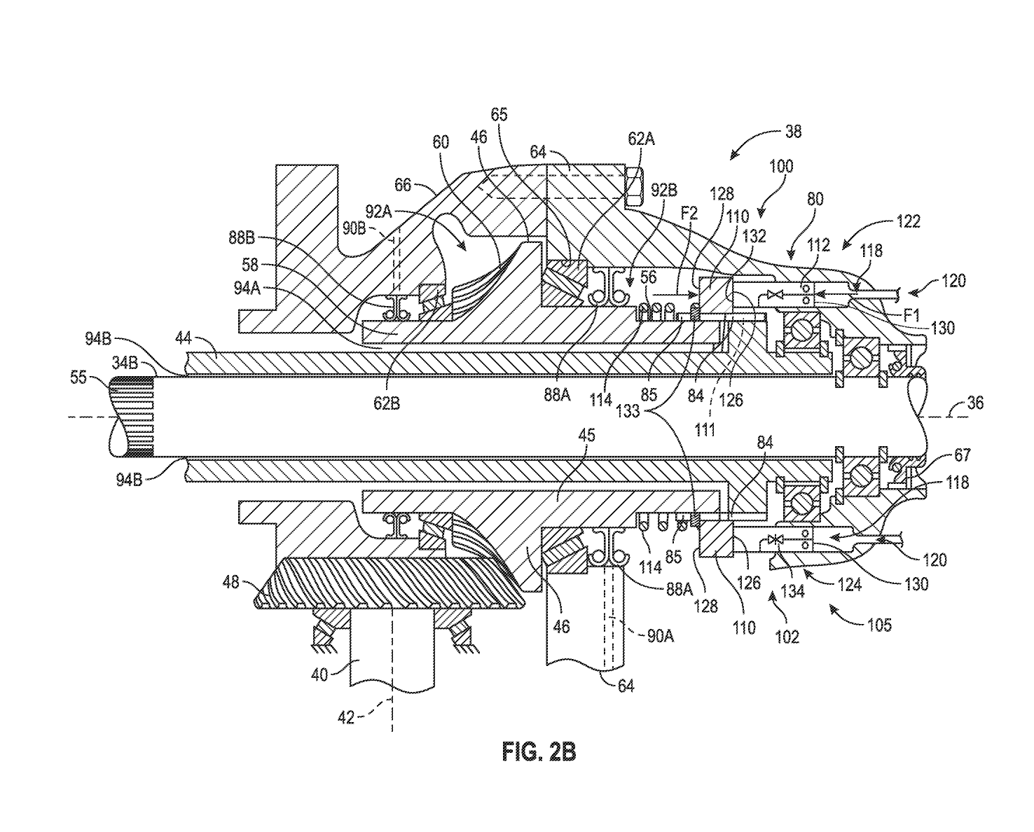

Referring now to FIG. 2A, the transmission output shaft 20 includes an output gear 21, such as a bevel gear, a helical gear, and the like, that meshes with drive gear 22, such as a bevel gear, a helical gear, and the like, operatively attached to a carrier 24 of the front differential 26, such that rotation of the transmission output shaft 20 causes the carrier 24 to rotate. The transmission output shaft 20 may also be connected to the carrier 24 via a chain drive. The front differential 26 is also referred to herein as a transmission differential 26. The front differential 26 mounts within the transmission housing 18. The differential 26 includes interconnected pinion gears 30A, 30B that, in general, rotate in unison with the differential carrier 24. The pinion gears 30A, 30B mesh with side gears 32A, 32B. Side gear 32A is mounted to rotate with a first half shaft 34A that is connected to rotate with a left front wheel 33A (FIG. 1). Side gear 32B is mounted to rotate with a second half shaft 34B that is connected to rotate with a right front wheel 33B (FIG. 2). The differential helical gear 22, differential carrier 24, side gears 32A, 32B, and half shafts 34A, 34B all rotate about a first axis of rotation 36. The transmission differential 26 is designed to allow side-to-side variation of wheel speeds, and the differential carrier 24 spins at the average of these speeds.

Referring again to FIG. 1, the power transfer unit assembly 38 operatively connects the differential carrier 24 to a driven member or a propeller shaft 40 that, in turn, connects to rear wheels 33C through a rear differential 25. The propeller shaft 40 includes a pinion gear 48 that is in meshing relationship to the hypoid ring gear 46. The propeller shaft 40 is arranged to rotate about a second axis of rotation 42 that, in the embodiment shown, is substantially perpendicular to the first axis of rotation 36, but is offset from and does not intersect the first axis of rotation 36. That is, in FIG. 1, the second axis of rotation 42 is above or below the plane of the cross-section that includes the first axis of rotation 36.

Accordingly, the power transfer unit assembly 38 enables driving torque ultimately provided by the engine 14 through the front differential 26 to front wheels to also be directed to rear wheels via the propeller shaft 40, such as in an all wheel-drive mode of operation.

As discussed further herein, the power transfer unit assembly 38 includes an input shaft 44, a bevel gear set with a first bevel gear 46 and a second bevel gear 48, and a stationary housing 50 surrounding and supporting the bevel gears 46, 48. The bevel gears 46, 48 may be hypoid spiral gears but are not limited to such. As used herein, the first bevel gear 46 is referred to as a hypoid ring gear 46 and the second bevel gear 48 is referred to as a pinion gear 48.

The power transfer unit assembly 38 is arranged with torque transfer components concentric with and rotatable about a single axis (the first axis of rotation 36). Because the components are arranged about a single axis of rotation 36, the overall radial dimension of each of the power transfer unit assembly 38 may be kept relatively small, enabling packaging into a fixed available packaging space adjacent the engine block 15.

Referring again to FIG. 2A, the input shaft 14 extends from the differential carrier 24, along the first axis of rotation 36, such that the input shaft 44 is configured to be rotatably driven by the differential carrier 24 about the first axis of rotation 36. The input shaft 44 is connected to rotate in unison with the transmission differential carrier 24, as schematically depicted in FIG. 2A. A splined portion 54 of the input shaft 44 fits to a splined opening of the differential carrier 24. The half shaft 34B extends through the input shaft 44, along the first axis of rotation 36. A splined portion 55 of the half shaft 34B is splined to the side gear 32B.

Referring to FIG. 2B, the hypoid ring gear 46 is annular and concentrically surrounds the input shaft 44, about the first axis of rotation 36. The hypoid ring gear 46 has a first annular shaft portion 56, a second annular shaft portion 58, and a tooth portion 60. The hypoid ring gear 46 may be supported by only two annular bearings 62A, 62B. Bearing 62A supports the shaft portion 56 for rotation relative to a cover housing 64 that is connected to a stationary housing 66 that surrounds and supports the hypoid ring gear 46 and the pinion gear 48. The cover housing 64 has an opening 65 through which the shaft portion 56, input member 44, and half shaft 34B extends. Bearing 62B supports the shaft portion 58 for rotation relative to a stationary housing 66.

The hypoid ring gear 46 is engaged with (i.e., meshes with) the pinion gear 48. The pinion gear 48 meshes with the hypoid ring gear 46 in a different plane than the cross-section through the center of the hypoid ring gear 46. In other words, the pinion gear 48 is offset from the hypoid ring gear 46 so that the second axis of rotation 42 does not intersect the first axis of rotation 36. In FIG. 2B, the pinion gear 48 is above the cross-section shown. The pinion gear 48 drives the propeller shaft 40 about the second axis of rotation 42, and may be connected to the propeller shaft 40 through a U-joint (not shown), or other appropriate connection. The ability to engage the pinion gear 48 at an offset with the hypoid ring gear 46 allows the position of the pinion gear 48, and thus the propeller shaft 40, to be higher or lower relative to the front half shafts 34A, 34B as required to accommodate a vehicle floor height, ground clearance, or other vehicle components, such as a steering rack or cradle.

The cover housing 64 provides a location for an annular double lip seal 88A that seals between the shaft portion 56 of the hypoid ring gear 46 and the cover housing 64. Another annular double lip seal 88B seals between the shaft portion 58 of the hypoid ring gear 46 and the housing 66. A passage 90A is provided in the cover housing 64 in communication with the lip seal 88A. An end of the passage 90A can be at a location at the underside of the power transfer unit assembly 38 that is easily accessed for inspection. The passage 90A can be referred to as a weep hole, as it provides an indication of leakage past the lip seal 88A if fluid weeps through the passage 90A. A similar passage 90B is provided in the housing 66 in communication with the lip seal 88B to provide an indication of leakage past the lip seal 88B.

The housing 66 and the cover housing 64 define a first cavity 92A that contains the hypoid ring gear 46 and the pinion gear 48. The cover housing 64 and the lip seals 88A, 88B substantially isolate the first cavity 92A from the second cavity 92B. This enables the use of different fluids in the two cavities. For example, the first cavity 92A can be filled with hypoid gear lubrication fluid that has a relatively high viscosity. A lower viscosity fluid, such as automatic transmission fluid (ATF) can be provided from the transmission 16 and differential housing 28 to the second cavity 92B through an annular passage 94A between the hypoid ring gear 46 and the input shaft 44, and through an annular passage 94B between the input shaft 44 and the half shaft 34B. By using lower viscosity transmission fluid in the second cavity 92B and isolating the higher viscosity gear lube in the first cavity 92A, spin losses are reduced. The lip seals 88A, 88B serve an additional function of increasing the drag on the rotating hypoid gear 46 to help keep it stationary about the first axis of rotation 36 when in a front-wheel drive mode. Lip seal 67 seals between the cover housing 64 and the half shaft 34B, and is the only seal at which there is relative motion when a disconnect clutch 80 (described in detail below) is disengaged. An alternative method to separate the two cavities 92A, 92B would be to place seals between the rotating hypoid ring gear 46 and input shaft 44, and between the input shaft 44 and half shaft 34B. In such an embodiment, the housing 66 would have an opening with a drain and fill plug to allow the cavity 92B to be filled with fluid.

With continued reference to FIG. 2B, the power transfer unit assembly 38 includes the disconnect mechanism 80 arranged to be concentric with the first axis of rotation 36, and also configured to selectively transfer torque from the input shaft 44 to the hypoid ring gear 46. The disconnect mechanism 80 is operatively disposed in the second cavity 92B. The disconnect mechanism 80 is configured to move between a disengaged position 100, shown in FIG. 2A, and an engaged position 102, shown in FIG. 2B. It should be appreciated that the disconnect mechanism 80 is symmetric about the first axis of rotation 36 and also some components are removed for purposes of clarity in the drawings. The disconnect mechanism 80 selectively operatively connects the input shaft 44 with the hypoid ring gear 46. More specifically, when the disconnect mechanism 80 is in the engaged position 102, shown in FIG. 2B, torque is transferred from the input shaft 44 to the hypoid ring gear 46. Conversely, when the disconnect mechanism 80 is in the disengaged position 100, shown in FIG. 2A, the input shaft 44 is disengaged from the hypoid ring gear 46 such that torque is not transferred from the input shaft 44 to the hypoid ring gear 46. Thus, the power transfer unit assembly 38 provides an all-wheel drive mode in the vehicle 10 of FIG. 1 when the disconnect mechanism 80 is in the engaged position 102, shown in FIG. 2B, and provides a front-wheel drive mode when the disconnect mechanism 80 is in the disengaged position 100, shown in FIG. 2A, as no torque will be transferred to the hypoid ring gear 46.

The disconnect mechanism 80 is hydraulically actuated. The disconnect mechanism 80 may be configured to move from the disengaged position 100, as shown in FIG. 2A, to the engaged position 102, as shown in FIG. 2B, in response to fluid received from the transmission 16. Referring again to FIG. 2A, the powertrain 12 includes a fluid feed circuit 103 where fluid may be selectively drawn from the transmission 16 from a sump 104, via a pump 106, to move fluid, under pressure, from the transmission 16, into the power transfer unit assembly 38. Alternatively, hydraulic line pressure of the transmission 16 may be utilized to selectively move the fluid, under pressure, from the transmission 16 into the power transfer unit assembly 38 to actuate the disconnect mechanism 80. Movement of the fluid from the transmission 16 to the power transfer unit assembly 38 may be effectuated under the control of a controller (not shown), that determines the operating conditions under which an all-wheel drive mode is established.

The disconnect mechanism 80 includes a selectively engageable torque transmitting device 110, a piston 112, and a return spring 114. The torque transmitting device 110 may be a clutch, such as a dog clutch and the like, that is axially movable along the shaft portion 56, by the piston 112. The torque transmitting device will be referred to from herein as a clutch 110. Referring to FIG. 2A, when the disconnect mechanism 80 is in the disengaged position 100, the clutch 110 radially surrounds the input shaft 44 and is slidably engaged with a first set of teeth 84 disposed on an outer circumference of the input shaft 44. More specifically, the clutch 110 includes a plurality of inner teeth 111 that radially surround the outer circumference of the input shaft 44 such that the inner teeth 111 are in meshing relationship with the first set of teeth 84 when the disconnect mechanism 80 is in the disengaged position 100. When the disconnect mechanism 80 is in the disengaged position 100, the hypoid ring gear 46 is not driven by the input shaft 44, and remains stationary. When the disconnect mechanism 80 moves to the engaged position 102, shown in FIG. 2B, the inner teeth 111 of the clutch 110 slides axially such that the clutch 110 radially surrounds the input shaft 44 and the hypoid ring gear 46 such that the inner teeth 111 are in meshing relationship with the first set of teeth 84 on the outer circumference of the input shaft 44 and a second set of teeth 85 on an outer circumference of the hypoid ring gear 46 to rotatably connect the input shaft 44 to the hypoid ring gear 46. Therefore, when the disconnect mechanism 80 is in the engaged position 102, shown in FIG. 2B, the hypoid ring gear 46 is driven by the input shaft 44. As such, the power transfer unit assembly 38 is a single axis power transfer unit able to share the same first and second axes of rotation 36, 42 and the same hypoid ring gear 46 and pinion gear 48 as the power transfer unit assembly 38, but with the input member 44 only able to transfer torque to the propeller shaft 40 of FIG. 2A with a torque reduction ratio provided only by the hypoid ring gear 46 and pinion gear 48. The torque transmitting device 110 may include a synchronizing mechanism (not shown) that is configured to equalize a rotational speed between the ring gear 46 and the input shaft 44, thus allowing a smooth engagement between the clutch 110 and the ring gear 46.

The cover housing 64 defines a pocket 118 radially surrounding the first axis of rotation 36. The piston 112 is operatively disposed to be at least partially within the pocket 118 such that the piston 112 is axially adjacent and in contact relationship with a first side 126 of the clutch 110. The piston 112 includes a pressure side 130 and an apply side 132, opposite the pressure side 130. The pressure side 130 faces the pocket 118 and the apply side 132 faces the first side 126 of the clutch 110. As will be explained in more detail below, the piston 112 is configured to move axially from a first position 122 to a second position 124, in response to a pressure force F1 applied to the pressure side 130 of the piston 112 within the pocket 118, by pressure of fluid received in the pocket 118, from the transmission 16.

The return spring 114 is axially disposed adjacent the clutch 110 such that the spring 114 axially acts on a second side 128 of the clutch 110, opposite the first side 126. Therefore, the return spring 114 continuously applies a spring force F2 to the second side 128 of the clutch 110, while the pressure force Fl is applied to the first side 126 of the clutch 110, via the piston 112. The clutch 110 selectively moves from the disengaged position 100, as shown in FIG. 2A, to the engaged position 102, as shown in FIG. 2B, when the pressure force F1 is sufficient to overcome the spring force F2. Likewise, the clutch 110 selectively moves from the engaged position 102, as shown in FIG. 2B, to the disengaged position 100, as shown in FIG. 2A, when the spring force F2 is sufficient to overcome the pressure force F1. The travel of the clutch 110 is limited by a positive stop 133.

The cover housing 64 also defines at least one inlet opening 120 that fluidly connects the pocket 118 with the transmission 16. Therefore, when fluid is selectively drawn from the transmission 16, via the pump 106 and the like, to the pocket 118, fluid pressure within the pocket 118 increases such that the fluid, under pressure, applies the pressure force F1 to the pressure side 130 of the piston 112. Since the apply side 132 of the piston 112 is in contact relationship with the first side 126 of the clutch 110, this pressure force F1 is transmitted axially from the piston 112 to the clutch 110.

The piston 112 may also include a valve 134, such as a bleed valve and the like, that provides fluid communication from the pocket 118 to the second cavity 92B via a bleed circuit 105. As such, the fluid will be slowly released from the pocket 118 to the second cavity 92B. The pressure within the pocket 118 is defined by a balance between the rate and pressure fluid is applied and the size of the orifice through which the fluid flows into the pocket 118. Therefore, the fluid mixes with the fluid already in the second cavity 92B. This fluid would then flow back to the transmission 16 through the annular passage 94A between the hypoid ring gear 46 and the input shaft 44, and through the annular passage 94B between the input shaft 44 and the half shaft 34B.

Alternatively, the fluid feed circuit 103 may also include a dump circuit configured to improve the speed at which the piston 112 could be returned to the disengaged position 100, illustrated in FIG. 2A. Therefore, the dump circuit would be in addition to the piston bleed circuit 105.

The power transfer unit assembly 38 may be modular, as the assembly 38 has a base of a housing 66, an input shaft 44, a hypoid ring gear 46, and a pinion gear 48. Using common components such as the hypoid ring gear 46 and pinion gear 48, and maintaining the components that accomplish the additional torque reduction concentric with a single axis (the first axis of rotation 36) may reduce weight, cost, and packaging space requirements in comparison to a two-axis torque reduction arrangement.

While the best modes for carrying out the many aspects of the present teachings have been described in detail, those familiar with the art to which these teachings relate will recognize various alternative aspects for practicing the present teachings that are within the scope of the appended claims.

1. A power transfer unit assembly for selectively transferring torque from a powertrain to a driven member of a vehicle to a driven member, the power transfer unit assembly comprising:
an input shaft configured to be rotatably driven by an output shaft of the powertrain, about a first axis of rotation;
a transfer shaft concentrically surrounding the input shaft, the transfer shaft having a first bevel gear;
wherein the first bevel gear is configured to be meshingly engaged with the driven member to selectively rotatably drive the driven member about a second axis of rotation; and
a disconnect mechanism disposed between the input shaft and the transfer shaft, wherein the disconnect mechanism is configured to selectively drive the transfer shaft by the input shaft;
wherein the input shaft is disconnected from the transfer shaft and torque is not transferred to the driven member when the disconnect mechanism is disengaged, and the input shaft is operatively connected to the transfer shaft and torque is transferred from the input shaft to the driven member when the disconnect mechanism is in the engaged position.

2. The power transfer unit, as set forth in claim 1, wherein the disconnect mechanism includes:
a piston; and
a clutch disposed axially adjacent the piston;
wherein the piston is movable axially from a first position to a second position in response to the application of a force to the piston; and
wherein the clutch is selectively movable axially from a disengaged position to an engaged position in response to movement of the piston from the first position to the second position.

3. The power transfer unit assembly of claim 2, wherein the input shaft includes a first set of teeth disposed on an outer circumference;
wherein the first bevel gear includes a second set of teeth disposed on an outer circumference;
wherein the clutch radially surrounds the input shaft such that the clutch is slidably engaged with the first set of teeth when the disconnect mechanism is in the disengaged position; and
wherein the clutch radially surrounds the input shaft and the first bevel gear such that the clutch is slidably engaged with the first set of teeth and the second set of teeth when the disconnect mechanism is in the engaged position.

4. The power transfer unit assembly of claim 3, wherein the clutch is a dog clutch including a plurality of inner teeth;
wherein the inner teeth are in meshing relationship with only the first set of teeth when the disconnect mechanism is in the disengaged position; and
wherein the inner teeth are in meshing relationship with the first set of teeth and the second set of teeth when the disconnect mechanism is in the disengaged position.

5. The power transfer unit assembly of claim 2, wherein the clutch includes a first side and a second side, in opposition to the first side;
wherein the piston includes a pressure side and an apply side, in opposition to the first side;
wherein the apply side of the piston is axially disposed in contact relationship with the first side of the piston; and
wherein the piston is movably axially from the first position to the second position in response to the application of the force to the pressure side of the piston.

6. The power transfer unit assembly of claim 1, further comprising:
a housing substantially surrounding the bevel gear; and
a cover housing attached to the housing and substantially surrounding the disconnect mechanism;
wherein the cover housing defines a pocket at least partially surrounding the first axis of rotation;
wherein the disconnect mechanism is at least partially disposed in the pocket such that the disconnect mechanism is in fluid communication with the pocket; and
wherein the pocket is configured to selectively receive fluid under pressure such that the force is applied to disconnect mechanism to engage the disconnect mechanism to operatively connect the input shaft and the transfer shaft.

7. The power transfer unit of claim 6, wherein the disconnect mechanism includes:
a piston; and
a clutch disposed axially adjacent the piston;
wherein the piston is movable axially from a first position to a second position in response to the application of a force to the piston; and
wherein the clutch is selectively movable axially from a disengaged position to an engaged position in response to movement of the piston from the first position to the second position.

8. The power transfer unit assembly of claim 7, wherein the clutch includes a first side and a second side, in opposition to the first side;
wherein the piston includes a pressure side and an apply side, in opposition to the first side;
wherein the apply side of the piston is axially disposed in contact relationship with the first side of the piston; and
wherein the piston is movably axially from the first position to the second position in response to the application of the force to the pressure side of the piston.

9. The power transfer unit assembly of claim 8, wherein the piston is at least partially disposed in the pocket such that the pressure side is in fluid communication with the pocket and the apply side of the piston is axially disposed in contact relationship with the first side of the piston; and
wherein the pocket is configured to selectively receive fluid under pressure such that the force is applied to the pressure side of the piston.

10. The power transfer unit assembly of claim 8, wherein the disconnect mechanism further includes a return spring axially disposed adjacent the clutch such that the return spring axially acts to apply a spring force to the second side of the clutch, axially opposite the force of the fluid acting on the piston;
wherein the clutch axially moves from the disengaged position to the engaged position when the force of the fluid acting on the piston exceeds the spring force of the return spring acting on the clutch; and
wherein the clutch axially moves from the engaged position to the disengaged position when the spring force of the return spring acting on the clutch exceeds the force of the fluid acting on the piston.

11. The power transfer unit assembly of claim 7, wherein the piston includes at least one valve in one-way fluid communication between the pocket and the second cavity such that the fluid is permitted to flow through the valve from the pocket to the second cavity.

12. The power transfer unit assembly of claim 1, wherein the first axis of rotation is substantially perpendicular and offset from the second axis of rotation such that the first axis of rotation and the second axis of rotation do not intersect.

13. A powertrain for a vehicle, the powertrain comprising:
a transmission including an output member;
a front differential including a differential carrier;
a helical gear operatively attached to the differential carrier of the front differential such that the transmission output member is configured to rotate in unison with the differential carrier;
wherein the differential carrier is rotatable about a first axis of rotation;
a propeller shaft, rotatable about a second axis of rotation; and
power transfer unit assembly for selectively transferring torque from the differential carrier to the propeller shaft, the power transfer unit assembly including:
an input shaft configured to be rotatably driven by the differential carrier about a first axis of rotation;
a transfer shaft concentrically surrounding the input shaft, the transfer shaft having a first bevel gear;
wherein the first bevel gear is meshingly engaged with the propeller shaft to selectively rotatably drive the propeller shaft about a second axis of rotation; and
a disconnect mechanism disposed between the input shaft and the transfer shaft, wherein the disconnect mechanism is configured to selectively drive the transfer shaft by the input shaft;
wherein the input shaft is disconnected from the transfer shaft and torque is not transferred to the propeller shaft when the disconnect mechanism is disengaged, and the input shaft is operatively connected to the transfer shaft and torque is transferred from the input shaft to the propeller shaft when the disconnect mechanism is in the engaged position.

14. The powertrain of claim 13, wherein the disconnect mechanism includes:
a piston; and
a clutch disposed axially adjacent the piston;
wherein the piston is movable axially from a first position to a second position in response to the application of a force to the piston; and
wherein the clutch is selectively movable axially from a disengaged position to an engaged position in response to movement of the piston from the first position to the second position.

15. The powertrain of claim 14, wherein the input shaft includes a first set of teeth disposed on an outer circumference;
wherein the first bevel gear includes a second set of teeth disposed on an outer circumference;
wherein the clutch radially surrounds the input shaft such that the clutch is slidably engaged with the first set of teeth when the disconnect mechanism is in the disengaged position; and
wherein the clutch radially surrounds the input shaft and the first bevel gear such that the clutch is slidably engaged with the first set of teeth and the second set of teeth when the disconnect mechanism is in the engaged position.

16. The powertrain of claim 14, wherein the clutch includes a first side and a second side, in opposition to the first side;
wherein the piston includes a pressure side and an apply side, in opposition to the first side;
wherein the apply side of the piston is axially disposed in contact relationship with the first side of the piston; and
wherein the piston is movably axially from the first position to the second position in response to the application of the force to the pressure side of the piston.

17. The powertrain of claim 16, further comprising:
a housing substantially surrounding the bevel gears;
a cover housing attached to the housing and substantially surrounding the disconnect mechanism;
wherein the cover housing defines a pocket at least partially surrounding the first axis of rotation;
wherein the piston is at least partially disposed in the pocket such that the pressure side is in fluid communication with the pocket and the apply side of the piston is axially disposed in contact relationship with the first side of the piston; and
wherein the pocket is configured to selectively receive fluid under pressure such that the force is applied to the pressure side of the piston.

18. The powertrain of claim 17, wherein the disconnect mechanism further includes a return spring axially disposed adjacent the clutch such that the return spring axially acts to apply a spring force to the second side of the clutch, axially opposite the force of the fluid acting on the piston;
wherein the clutch axially moves from the disengaged position to the engaged position when the force of the fluid acting on the piston exceeds the spring force of the return spring acting on the clutch; and
wherein the clutch axially moves from the engaged position to the disengaged position when the spring force of the return spring acting on the clutch exceeds the force of the fluid acting on the piston.

19. The powertrain of claim 18, further comprising:
a bearing disposed between the cover housing and a shaft portion of the first bevel gear; and
a lip seal disposed between the shaft portion of the first bevel gear and the cover housing;
wherein the housing and the cover housing define a first cavity containing the first and the second bevel gears;
wherein the cover and the cover housing define a second cavity containing the disconnect mechanism;
wherein the cover housing and the lip seal substantially isolate the first cavity from the second cavity, thereby permitting a first fluid in the first cavity to be isolated from a second fluid in the second cavity; and
wherein the piston includes at least one valve in one-way fluid communication between the pocket and the second cavity such that the fluid is permitted to flow through the valve from the pocket to the second cavity.

20. The powertrain of claim 13, wherein the propeller shaft includes a second bevel gear radially surrounding the second axis of rotation; and
wherein the second bevel gear is in meshing relationship with the first bevel gear such that the first axis of rotation is substantially perpendicular and offset from the second axis of rotation and the first axis of rotation and the second axis of rotation do not intersect.
